(19) United States
(12) Patent Application Publication
(10) Pub. No.: US 2026/0106536 A1
(43) Pub. Date: Apr. 16, 2026

(54) METHOD AND SYSTEM FOR SUPPRESSING DIRECT CURRENT-LINK CAPACITOR CURRENT RIPPLE OF COUPLED THREE-LEVEL INVERTER

(71) Applicant: SHANDONG JIANZHU UNIVERSITY, Jinan (CN)

(72) Inventors: Xiaoyan LI, Jinan (CN); Changwei QIN, Jinan (CN); Chengdong LI, Jinan (CN); Zhiyuan CHU, Jinan (CN); Chuanjing HOU, Jinan (CN); Hongchao BAI, Jinan (CN); Dongjiang YANG, Jinan (CN); Dingguo AN, Jinan (CN); Lei YANG, Jinan (CN)

(21) Appl. No.: 19/315,930

(22) Filed: Sep. 2, 2025

(30) Foreign Application Priority Data
Oct. 11, 2024 (CN) 2024114179735

(51) Int. Cl. H02M 1/15; H02M 7/487; H02M 7/5387; H02M 7/5395

(52) U.S. Cl. CPC H02M 1/15; H02M 7/487; H02M 7/53873; H02M 7/5395

(57) ABSTRACT

A method for suppressing a direct current-link (DC-Link) capacitor current ripple (CCR) of a coupled three-level inverter (TLI), including: dividing space vector diagram regions of coupled TLI based on value range of virtual voltage vector duty cycle distribution factor; determining, based on amplitude, phase angle, and three-phase output current of reference voltage vector, sector and region in which reference voltage vector is located; then selecting nearest one virtual voltage vector and two basic voltage vectors, to calculate duty cycles thereof, respectively; designing a controller, updating duty cycle distribution factor of small vector based on sector and region in which reference voltage vector is located, set value of voltage difference across DC-Link capacitors, and actual value of voltage difference across DC-Link capacitors; and designing switching sequence based on updated small vector duty cycle and sector and region in which reference voltage vector is located.

### CROSS-REFERENCE TO RELATED APPLICATIONS

The present invention claims priority to Chinese Patent Application No. 202411417973.5, filed with the China National Intellectual Property Administration on Oct. 11, 2024 and entitled “METHOD AND SYSTEM FOR SUPPRESSING DIRECT CURRENT-LINK CAPACITOR CURRENT RIPPLE OF COUPLED THREE-LEVEL INVERTER”, which is incorporated herein by reference in its entirety and constitutes a part of the present invention, for all purposes.

### TECHNICAL FIELD

The present invention belongs to the technical field of power transactions on power electronics, and specifically, to a method and a system for suppressing a direct current-link (DC-Link) capacitor current ripple (CCR) of a coupled three-level inverter (TLI).

### BACKGROUND

The description in this section merely provides background information related to the present invention and does not necessarily constitute the prior art.

The TLI is widely used in new energy power generation, motor drives, and energy storage systems owning to the advantages such as a simple structure, good quality of output current waveforms, and high efficiency. A T-type TLI is a common circuit topology, but includes a large quantity of power switches. The coupled TLI includes only ten power switches, a quantity of the power switches is further reduced, and multi-level output characteristics are maintained, to have a wide application prospect.

An electrolytic capacitor is a component that is highly susceptible to failure, and stability of the electrolytic capacitor directly determines output waveform quality of the inverter. A DC-Link CCR is defined as a root-mean-square value of a neutral point current. When the DC-Link CCR is very high, a lifetime of the capacitor is shortened, and even the inverter is directly damaged. A large capacitor may prolong a lifetime of an inverter, but increases a system volume and costs.

The inventor finds that the existing method for suppressing a DC-Link CCR is mainly for a T-type or hybrid active neutral-point-clipped (HANPC) TLI topology. When the coupled TLI operates in an operating condition in which capacitor voltages on the DC-Link are not equal, output current harmonics of the coupled TLI increase. In addition, an output state of the topology is limited, and a medium vector cannot be generated. Therefore, the existing control method cannot be directly applied, and a method for suppressing a DC-Link CCR of a coupled TLI suitable for an unbalanced operating condition is urgently to be studied.

### SUMMARY

To resolve the foregoing problem, the present invention proposes a method and a system for suppressing a DC-Link CCR of a coupled TLI. The present invention can effectively suppress a DC-Link CCR of a coupled TLI while maintaining good waveform quality of an output current, and is suitable for operating conditions in which capacitor voltages on the DC-Link are balanced and unbalanced.

According to some examples, a first solution of the present invention provides a method for suppressing a DC-Link CCR of a coupled TLI, and the following technical solutions are used.

The method for suppressing a DC-Link CCR of a coupled TLI, including:
determining a region division method of a space vector diagram of a coupled TLI based on a value range of a duty cycle distribution factor of a virtual voltage vector;
determining, based on an amplitude, a phase angle, and a three-phase output current of a reference voltage vector, a sector and a region in which the reference voltage vector is located;
selecting, based on the sector and the region in which the reference voltage vector is located, nearest one virtual voltage vector and two basic voltage vectors, to calculate duty cycles of the nearest one virtual voltage vector and two basic voltage vectors respectively;
designing a controller, updating a duty cycle distribution factor of a small vector, and realizing separate control of capacitor voltages based on the sector and the region in which the reference voltage vector is located, a set value of a voltage difference across DC-Link capacitors, and an actual value of a voltage difference across DC-Link capacitors according to a deadbeat control method; and
designing a switching sequence based on an updated small vector duty cycle and the sector and the region in which the reference voltage vector is located, and converting the switching sequence into a PWM drive signal of a power switch, to control the coupled TLI to operate.

According to some examples, a second solution of the present invention provides a system for suppressing a DC-Link CCR of a coupled TLI, and the following technical solutions are used.

The system for suppressing a DC-Link CCR of a coupled TLI, including:
a sector division module, configured to determine a region division method of a space vector diagram of a coupled TLI based on a value range of a duty cycle distribution factor of a virtual voltage vector;
a sector determining module, configured to determine, based on an amplitude, a phase angle, and a three-phase output current of a reference voltage vector, a sector and a region in which the reference voltage vector is located;
a basic voltage vector selection module, configured to select, based on the sector and the region in which the reference voltage vector is located, nearest one virtual voltage vector and two basic voltage vectors, to calculate duty cycles of the nearest one virtual voltage vector and two basic voltage vectors respectively;
a capacitor voltage separate control module, configured to: design a controller, update a duty cycle distribution factor of a small vector, and realize separate control of capacitor voltages based on the sector and the region in which the reference voltage vector is located, a set value of a voltage difference across DC-Link capacitors, and an actual value of a voltage difference across DC-Link capacitors according to a deadbeat control method; and
a drive signal generation module, configured to: design a switching sequence based on an updated small vector duty cycle and the sector and the region in which the reference voltage vector is located, and convert the switching sequence into a PWM drive signal of a power switch, to control the coupled TLI to operate.

According to some examples, a third solution of the present invention provides a computer-readable storage medium.

A computer-readable storage medium, having a computer program stored thereon, where when the program is executed by a processor, the steps of the method for suppressing a DC-Link CCR of a coupled TLI according to the first aspect are implemented.

According to some examples, a fourth solution of the present invention provides a computer device.

A computer device, including a memory, a processor, and a computer program that is stored in the memory and that can be run on the processor, where when the processor executes the program, the steps of the method for suppressing a DC-Link CCR of a coupled TLI according to the first aspect are implemented.

The beneficial effects of the present invention compared with the prior art are as follows.

Compared with a conventional space vector modulation method, in the present invention, the DC-Link CCR is obviously reduced, and a lifetime of the DC-Link capacitor can be prolonged. In operating conditions of balanced capacitor voltages and unbalanced capacitor voltages on the DC-Link, the method of the present invention reduces a total harmonic distortion of the three-phase output current of the coupled TLI, and improves system efficiency and stability. In the present invention, duty cycles of a P-type small vector and an N-type small vector are modified based on different sectors, regions, set values of the voltage difference across DC-Link capacitors, and actual values of the voltage difference across DC-Link capacitors, to implement separate control of capacitor voltages. Compared with the conventional space vector modulation method, in the present invention, only three voltage vectors are employed to synthesize the reference voltage vector without calculating a voltage vector duty cycle by using an indirect method, thereby reducing computational burden.

### BRIEF DESCRIPTION OF THE DRAWINGS

The accompanying drawings constituting a part of the present invention are used to provide a further understanding of the present invention. The illustrative examples of the present invention and descriptions thereof are used to explain the present invention, and do not constitute an improper limitation of the present invention.

FIG. 1 is a circuit topology diagram of a coupled TLI;

FIG. 2 is a space vector diagram of the coupled TLI when a DC-Link unbalanced factor is greater than 0;

FIG. 3 is a space vector diagram of the coupled TLI when the DC-Link unbalanced factor is less than 0;

FIG. 4 is a value range of a duty cycle distribution factor β of a virtual vector when a system uses a conventional space vector modulation method;

FIG. 5A shows a region division method of Sector 1 when a duty cycle distribution factor of a virtual voltage vector is 1 according to Example 1 of the present invention;

FIG. 5B shows a region division method of Sector 1 when the duty cycle distribution factor of the virtual voltage vector is 0 according to Example 1 of the present invention;

FIG. 6 is a schematic diagram of a switching sequence when a system uses a conventional space vector modulation method, and a reference voltage is located in an outer region of Sector 1;

FIG. 7 is a schematic diagram of a switching sequence when a system uses a control method of Example 1 of the present invention, and a reference voltage is located in Sector 1 and region A₁;

FIG. 8 is a principle diagram of a method for suppressing a DC-Link CCR according to Example 1 of the present invention;

FIG. 9A is a simulation waveform diagram in which a system uses a conventional space vector modulation method with a DC-Link unbalanced factor of 0.2 and a modulation index of 0.8;

FIG. 9B is a simulation waveform diagram in which the system uses the conventional space vector modulation method with the DC-Link unbalanced factor of −0.2 and the modulation index of 0.8;

FIG. 9C is a simulation waveform diagram in which the system uses the conventional space vector modulation method with the DC-Link unbalanced factor of 0 and the modulation index of 0.8;

FIG. 10A is a simulation waveform diagram in which the system uses a control method of Example 1 of the present invention with the DC-Link unbalanced factor of 0.2 and the modulation index of 0.8;

FIG. 10B is a simulation waveform diagram in which the system uses the control method of Example 1 of the present invention with the DC-Link unbalanced factor of −0.2 and the modulation index of 0.8;

FIG. 10C is a simulation waveform diagram in which the system uses the control method of Example 1 of the present invention with the DC-Link unbalanced factor of 0 and the modulation index of 0.8;

FIG. 11A is a simulation waveform diagram in which the system uses the conventional space vector modulation method with the DC-Link unbalanced factor of 0.2 and the modulation index of 0.4;

FIG. 11B is a simulation waveform diagram in which the system uses the conventional space vector modulation method with the DC-Link unbalanced factor of −0.2 and the modulation index of 0.4;

FIG. 11C is a simulation waveform diagram in which the system uses the conventional space vector modulation method with the DC-Link unbalanced factor of 0 and the modulation index of 0.4;

FIG. 12A is a simulation waveform diagram in which the system uses the control method of Example 1 of the present invention with the DC-Link unbalanced factor of 0.2 and the modulation index of 0.4;

FIG. 12B is a simulation waveform diagram in which the system uses the control method of Example 1 of the present invention with the DC-Link unbalanced factor of −0.2 and the modulation index of 0.4;

FIG. 12C is a simulation waveform diagram in which the system uses the control method of Example 1 of the present invention with the DC-Link unbalanced factor of 0 and the modulation index of 0.4;

FIG. 13A is a simulation waveform diagram in which the system uses the control method of Example 1 of the present invention, a modulation index is set to 0.8, and a unit step occurs in a set value of a voltage difference across DC-Link capacitors; and

FIG. 13B is a simulation waveform diagram in which the system uses the control method of Example 1 of the present invention, the modulation index is set to 0.4, and the unit step occurs in the set value of the voltage difference across DC-Link capacitors.

### DETAILED DESCRIPTION

The present invention is further explained with reference to the accompanying drawings and the examples.

It should be pointed out that the following detailed descriptions are all illustrative and are intended to provide further descriptions of the present invention. Unless otherwise specified, all technical and scientific terms used in this specification have the same meanings as those usually understood by a person of ordinary skill in the art to which the present invention belongs.

It should be noted that the terms used herein are merely used for describing specific implementations, and are not intended to limit exemplary implementations of the present invention. As used herein, the singular form is intended to include the plural form, unless the context clearly indicates otherwise. In addition, it should further be understood that terms “comprise/comprising” and/or “include/including” used in this specification indicate that there are features, steps, operations, devices, components, and/or combinations thereof.

The examples in the present invention and features in the examples may be combined with each other if there is no conflict.

### Example 1

The present example provides a method for suppressing a DC-Link CCR of a coupled TLI. In the present example, the method includes:
determining a region division method of a space vector diagram of a coupled TLI based on a value range of a duty cycle distribution factor of a virtual voltage vector;
determining, based on an amplitude, a phase angle, and a three-phase output current of a reference voltage vector, a sector and a region in which the reference voltage vector is located;
selecting, based on the sector and the region in which the reference voltage vector is located, nearest one virtual voltage vector and two basic voltage vectors, to calculate duty cycles of the nearest one virtual voltage vector and two basic voltage vectors respectively;
designing a controller, updating a duty cycle distribution factor of a small vector, and realizing separate control of capacitor voltages based on the sector and the region in which the reference voltage vector is located, a set value of a voltage difference across DC-Link capacitors, and an actual value of a voltage difference across DC-Link capacitors according to a deadbeat control method; and
designing a switching sequence based on an updated small vector duty cycle and the sector and the region in which the reference voltage vector is located, and converting the switching sequence into a PWM drive signal of a power switch, to control the coupled TLI to operate.

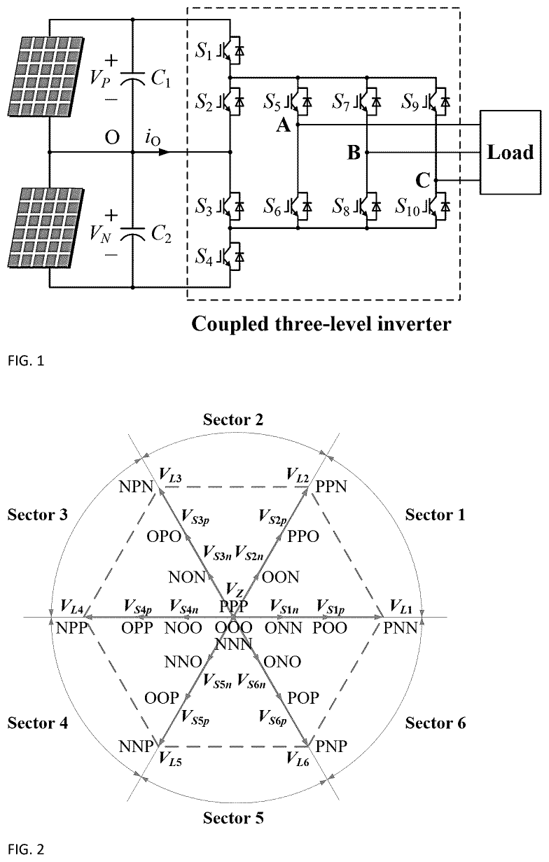

FIG. 1 is a system topology of a coupled TLI, which includes two photovoltaic arrays, two DC-Link electrolytic capacitors, a coupled TLI, and a three-phase load. Each of the two photovoltaic arrays is connected to an electrolytic capacitor, to further design a control strategy, implement separate maximum power point tracking (MPPT) functions of the photovoltaic arrays, and further improve system efficiency.

The power switch is an insulated-gate bipolar transistor (IGBT). The power switch may also be implemented by using a transistor in another form, and may be specifically selected according to an actual requirement of a person skilled in the art.

There are three switch states of the coupled TLI: P, O, and N. A neutral point O (see FIG. 1) on the DC-Link is selected as a reference. When the switch state is P, an output voltage of a bridge arm is +V_{P}; when the switch state is O, the output voltage of the bridge arm is 0; and when the switch state is N, the output voltage of the bridge arm is −V_{N}.

For ease of analysis, a DC-Link unbalanced factor μ is defined as follows:

$$μ = \frac{{V}_{P} - {V}_{N}}{{V}_{P} + {V}_{N}} = \frac{{V}_{diff}}{{V}_{dc}} ; \qquad ( 1 )$$

wherein, V_{P} and V_{N} are voltages across an upper-side capacitor and a lower-side capacitor respectively, V_{diff} is a voltage difference across two DC-Link capacitors (that is, V_{diff}=V_{P}−V_{N}), and V_{dc} is a sum of voltages across two DC-Link capacitors.

Based on formula (1), it may be obtained that expressions of the upper-side capacitor voltage and the lower-side capacitor voltage on the DC-Link are as follows:

$$\{ \begin{matrix}{V}_{P} = \frac{1 + μ}{2} {V}_{d c} \\ {V}_{N} = \frac{1 - μ}{2} {V}_{d c}\end{matrix} . \qquad ( 2 )$$

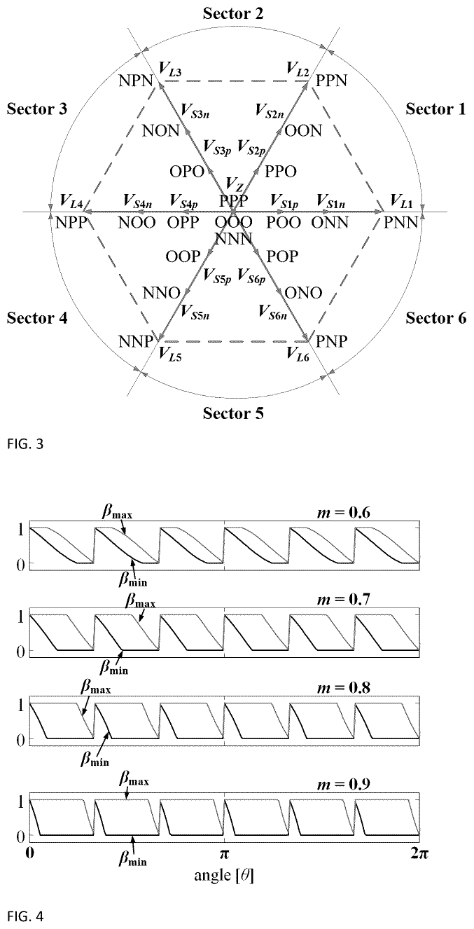

FIG. 2 and FIG. 3 are space vector diagrams of a coupled TLI when a DC-Link unbalanced factor is greater than or less than 0. The entire space vector diagram is divided into 6 sectors (that is, a first sector to a sixth sector, which can alternatively be expressed as Sector 1 to Sector 6). It can be seen that, in an operating condition of unbalanced neutral-point voltages on a DC-Link, locations of the large vector and the zero vector remain unchanged, that is, are the same as those in an operating condition of balanced neutral-point voltages; and a location of the small vector is shifted, and the small vector is no longer redundant, which makes the implementation process of the space vector modulation method extremely complicated.

Impact of all basic voltage vectors on the neutral point current (iₙₚ) is shown in Table 1. It is not difficult to find that only the small vector affects the neutral point current. In addition, a neutral point current generated by each pair of P-type small vector and a neutral point current generated by each pair of N-type small vector have equal amplitudes and opposite directions.

Without loss of generality, a specific implementation process is described in detail by using Sector 1 as an example.

The determining a region division method of a space vector diagram of a coupled TLI based on a value range of a duty cycle distribution factor of a virtual voltage vector is specifically:
separately synthesizing the first virtual voltage vector and the second virtual voltage vector based on the two pairs of small vectors in the first sector in the space vector diagram of the coupled TLI;
determining, based on two virtual voltage vectors and two large vectors, duty cycles of the two virtual voltage vectors according to an indirect method;
calculating duty cycle distribution factors of the virtual voltage vectors based on the duty cycles of the two virtual voltage vectors;
determining value ranges of the duty cycle distribution factors of the two virtual voltage vectors by considering a value range of a large vector, and considering that a duty cycle distribution factor of a small vector and a DC-Link unbalanced factor are equal to zero;
determining, based on a maximum value and a minimum value of the duty cycle distribution factors of the virtual voltage vectors, two straight lines passing through the first sector, where each of the two straight lines represents a connection line between a virtual voltage vector and a large vector; and
performing region division on the first sector of the space vector diagram of the coupled TLI by using the two straight lines as a region division condition. The specific descriptions are as follows.

Small vectors in Sector 1 include a first pair of small vectors [POO] (V_{S1p}) and [ONN] (V_{S1n}) and a second pair of small vectors [PPO] (V_{S2p}) and [OON] (V_{S2n}), magnitudes thereof are no longer equal, and it is difficult to synthesize a reference voltage vector. Therefore, each pair of small vectors are synthesized into a virtual voltage vector, and expressions thereof are as follows:

$$\{ \begin{matrix}{V}_{v 1} = α {V}_{S 1 p} + ( 1 - α ) {V}_{S 1 n} = \frac{1 + 2 α μ - μ}{3} {V}_{d c} {e}^{j 0} \\ {V}_{v 2} = α {V}_{S 2 p} + ( 1 - α ) {V}_{S 2 n} = \frac{1 + 2 α μ - μ}{3} {V}_{d c} {e}^{j \frac{π}{3}}\end{matrix} ; \qquad ( 3 )$$

wherein, Vᵥ₁ and Vᵥ₂ are two virtual vectors respectively representing the first virtual voltage vector and the second virtual voltage vector, and a is a duty cycle distribution factor of a small vector.

Therefore, all basic voltage vectors of Sector 1 are respectively represented as:

$$\{ \begin{matrix}{V}_{L 1} = \frac{2}{3} {V}_{d c} {e}^{j 0} \\ {V}_{L 2} = \frac{2}{3} {V}_{d c} {e}^{j \frac{π}{3}} \\ {V}_{v 1} = \frac{1 + 2 α μ - μ}{3} {V}_{d c} {e}^{j 0} \\ {V}_{v 2} = \frac{1 + 2 α μ - μ}{3} {V}_{d c} {e}^{j \frac{π}{3}} \\ {V}_{Z} = 0\end{matrix} ; \qquad ( 4 )$$

wherein, V_{L1}, V_{L2}, and V_{Z} respectively represent a large vector [PNN], a large vector [PPN], and a zero vector [OOO].

Table 1 Relationship between a neutral point current (iₙₚ) and a basic voltage vector

| Vector | Switch state | iₙₚ | Switch state | iₙₚ |
|---|---|---|---|---|
| Large | [PNN] | 0 | [NPP] | 0 |
| vector | [PPN] | 0 | [NNP] | 0 |
| | [NPN] | 0 | [PNP] | 0 |
| Small | [POO] | i_{b} + i_{c} = −iₐ | [ONN] | iₐ |
| vector | [PPO] | i_{c} | [OON] | iₐ + i_{b} = −i_{c} |
| | [OPO] | iₐ + i_{c} = −i_{b} | [NON] | i_{b} |
| | [OPP] | iₐ | [NOO] | i_{b} + i_{c} = −iₐ |
| | [OOP] | iₐ + i_{b} = −i_{c} | [NNO] | i_{c} |
| | [POP] | i_{b} | [ONO] | iₐ + i_{c} = −i_{b} |
| Zero | [PPP] | 0 | [OOO] | iₐ + i_{c} + i_{b} = 0 |
| vector | [NNN] | 0 | | |

### 1. Calculation of a Duty Cycle Distribution Factor of a Virtual Vector

When a reference voltage vector (V_{ref}) is located in an outer region of Sector 1, two virtual voltage vectors and two large vectors are used to synthesize a reference voltage, and a voltage-second balance equation thereof is:

$$\{ \begin{matrix}{V}_{L 1} {d}_{L 1} + {V}_{L 2} {d}_{L 2} + {V}_{v 1} {d}_{v 1} + {V}_{v 2} {d}_{v 2} = {V}_{r e f} \\ {d}_{L 1} + {d}_{L 2} + {d}_{v 1} + {d}_{v 2} = 1\end{matrix} ; \qquad ( 5 )$$

wherein, d_{L1}, d_{L2}, dᵥ₁, and dᵥ₂ respectively represent duty cycles of V_{L1}, V_{L2}, Vᵥ₁, and Vᵥ₂.

To simplify, a sum (dᵥ₁₂) of the duty cycles of the virtual vectors is:

$${d}_{v 12} = {d}_{v 1} + {d}_{v 2} = \frac{2 - 2 m sin ( \frac{π}{3} + θ )}{1 - 2 α μ + μ} ; \qquad ( 6 )$$

wherein, m is a modulation index, and is expressed as:

$$m = \frac{\sqrt{3} {V}_{ref}}{{V}_{d c}} . \qquad ( 7 )$$

Assuming that the duty cycle distribution factor of the virtual voltage vector is β, then a duty cycle of each virtual voltage vector (dᵥ₁ and dᵥ₂) can be represented as respectively:

$$\{ \begin{matrix}{d}_{v 1} = β {d}_{v 12} \\ {d}_{v 2} = ( 1 - β ) {d}_{v 12}\end{matrix} . \qquad ( 8 )$$

Therefore, duty cycles of the two large vectors are:

$${d}_{L 1} = m ( \frac{π}{3} - θ ) - \frac{β ( 1 + 2 α μ - μ ) [ 1 - m sin ( \frac{π}{3} + θ ) ]}{1 - 2 α μ + μ} , \qquad ( 9 )$$

$${d}_{L 2} = m sin θ - \frac{( 1 - β ) ( 1 + 2 α μ - μ ) [ 1 - m sin ( \frac{π}{3} + θ ) ]}{1 - 2 α μ + μ} . \qquad ( 10 )$$

Considering that d_{L1} and d_{L2} should be greater than 0, and 0≤β≤1, a maximum value βₘₐₓ and a minimum value βₘᵢₙ of β are respectively:

$${β}_{m ax} = \{ 1 , 1 - \frac{( 1 - 2 α μ + μ ) m sin θ}{( 1 + 2 α μ - μ ) [ 1 - m sin ( \frac{π}{3} + θ ) ]} \} , \qquad ( 11 )$$

$${β}_{m i n} = \{ 0 , \frac{( 1 - 2 α μ + μ ) m sin ( \frac{π}{3} - θ )}{( 1 + 2 α μ - μ ) [ 1 - m sin ( \frac{π}{3} + θ ) ]} \} . \qquad ( 12 )$$

### 2. Analysis of a Duty Cycle Distribution Factor of a Virtual Voltage Vector

When a duty cycle distribution factor α of a small vector and a DC-Link unbalanced factor μ are equal to 0, βₘₐₓ and βₘᵢₙ in different modulation indexes are shown in FIG. 4. It is not difficult to find that βₘₐₓ and βₘᵢₙ may be 0 or 1 within a particular range. In addition, as the modulation index increases, the maximum value and the minimum value of β may be 0 or 1 within a larger interval.

When βₘₐₓ is equal to 1, formula (11) may be represented as:

$$3 {V}_{ref} cos θ - \sqrt{3} ( 2 α μ - μ ) {V}_{ref} sin θ = ( 1 + 2 α μ - μ ) {V}_{d c} ; \qquad ( 13 )$$

and,
similarly, when βₘᵢₙ is equal to 0, formula (12) may be represented as:

$$3 ( 1 + 2 α μ - μ ) {V}_{ref} cos θ + \sqrt{3} ( 3 - 2 α μ + μ ) {V}_{ref} sin θ = ( 1 + 2 α μ - μ ) {V}_{d c} . \qquad ( 14 )$$

It can be seen that formula (13) and formula (14) respectively represent two straight lines passing through Sector 1. In this case, the two straight lines respectively pass through a small vector and a large vector, and a space vector diagram thereof is shown in FIG. 5. The foregoing two straight lines are used as a region division condition, and only three voltage vectors are employed to synthesize the reference voltage vector, thereby reducing computational burden.

When the reference voltage vector is located in Sector 1, small vectors [POO], [ONN], [PPO], and [OON] determine the neutral point current, that is, the output currents iₐ and i_{c} directly determine the DC-Link CCR. Therefore, a virtual voltage vector with relatively high neutral point current amplitude may be discarded to suppress the DC-Link CCR. Specifically, when |iₐ|≤|i_{c}|, β should be equal to 1, as shown in FIG. 5A. In this case, a virtual voltage vector Vᵥ₁, a large vector V_{L1}, and a large vector V_{L2} are employed to synthesize a reference voltage vector of Sector 1 and region A₁; and a virtual voltage vector Vᵥ₁, a large vector V_{L2}, and a zero vector V_{Z} are employed to synthesize a reference voltage vector of Sector 1 and region B₁. When |iₐ|>|i_{c}|, β should be 0, as shown in FIG. 5B. In this case, a virtual voltage vector Vᵥ₂, a large vector V_{L1}, and a large vector V_{L2} are employed to synthesize a reference voltage vector of Sector 1 and region A₂; and a virtual voltage vector Vᵥ₂, a large vector V_{L1}, and a zero vector V_{Z} are employed to synthesize a reference voltage vector of Sector 1 and region B₂. When the reference voltage vector is located in another sector other than Sector 1, a value of the duty cycle distribution factor of the virtual voltage vector may be obtained by using the foregoing principle, and details are not described herein again.

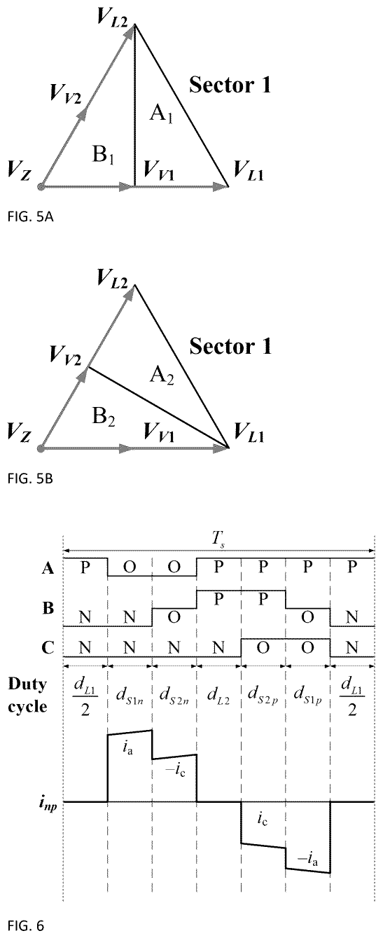

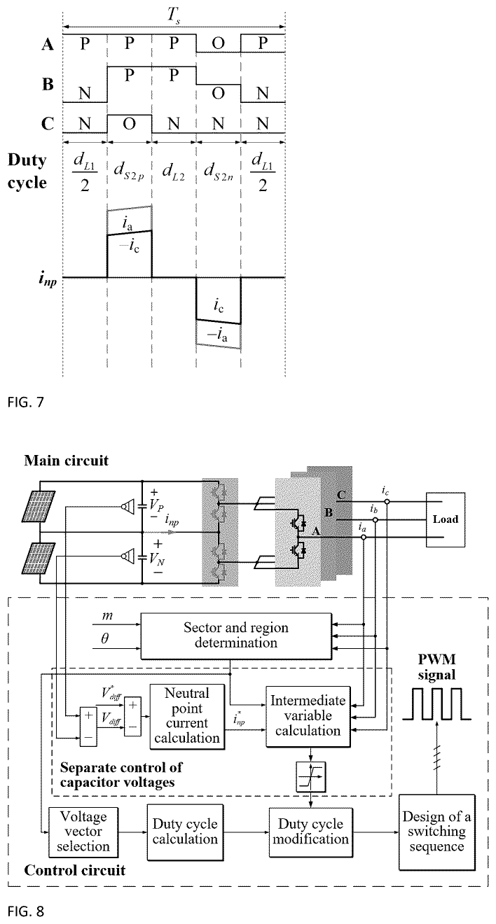

When |iₐ|≤|i_{c}|, FIG. 6 and FIG. 7 show neutral point currents and output voltage waveforms in the conventional method and the method of the present invention. Because the small vectors [POO] and [ONN] with relatively high neutral point current amplitudes are discarded, the method of the present invention can effectively reduce the DC-Link CCR.

### 3. Separate Control of Capacitor Voltages

As described above, in a large-capacity centralized photovoltaic power generation system, one photovoltaic array is connected at both ends of each of the DC-Link capacitors, to separately control voltages at both ends of the two capacitors C₁ and C₂ on the DC-Link, implement a separate MPPT function, and improve system efficiency. Therefore, the controller is designed according to the deadbeat control method, to precisely adjust the neutral point current, obtain duty cycle distribution factors of the P-type small vector and the N-type small vector, update a duty cycle of each basic voltage vector, and implement separate control of capacitor voltages.

According to Kirchhoff's Current Law (KCL), a mathematics model of the neutral point current may be represented as:

$${i}_{np} = {C}_{d c} ( \frac{d {V}_{P}}{d t} - \frac{d {V}_{N}}{d t} ) = {C}_{d c} \frac{d {V}_{diff}}{d t} ; \qquad ( 15 )$$

wherein, C_{dc} is a DC-Link capacitor, and C_{dc}=C₁=C₂.

Assuming that a sampling period is Tₛ, a discrete model of the neutral point current may be represented as:

$${i}_{np} ( k ) = {C}_{d c} \frac{{V}_{diff} ( k + 1 ) - {V}_{diff} ( k )}{{T}_{s}} ; \qquad ( 16 )$$

wherein, V_{diff}(k) and V_{diff}(k+1) respectively represent capacitor voltage differences in a k^{th} sampling period and a (k+1)^{th} sampling periods, and iₙₚ(k) is a neutral point current value of the k^{th} sampling period.

Let V_{diff}(k+1) be a set value of a voltage difference across capacitors

$${V}_{diff}^{*}$$

then a reference value of the neutral point current (

$${i}_{np}^{*}$$

may be represented as:

$${i}_{np}^{*} = {C}_{d c} \frac{{V}_{diff}^{*} - {V}_{diff}}{{T}_{s}} . \qquad ( 17 )$$

Specifically, when the reference voltage vector is located in Sector 1 (region A₁ and region B₁), that is, being located in a first region of a first sector, a relationship between a neutral point current and a duty cycle is:

$${i}_{np} = {i}_{a} {d}_{S 1 n} + {i}_{b} {d}_{S 1 p} + {i}_{c} {d}_{S 1 p} ; \qquad ( 18 )$$

wherein, d_{S1p} and d_{S1n} respectively represent duty cycles of the first pair of small vectors [POO] and [ONN], and iₐ, i_{b}, and i_{c} are respectively three-phase output currents of the inverter.

To implement separate control of capacitor voltages, duty cycles of d_{S1p} and d_{S1n} are modified as follows:

$$\{ \begin{matrix}{d}_{S 1 p} = \frac{1 + {y}_{np}}{2} {d}_{v 1} \\ {d}_{S 1 n} = \frac{1 - {y}_{np}}{2} {d}_{v 1}\end{matrix} ; \qquad ( 19 )$$

wherein, yₙₚ is an intermediate variable, and a relationship between yₙₚ and a duty cycle distribution factor α of a small vector is:

$$α = \frac{1 + {y}_{n p}}{2} . \qquad ( 20 )$$

With reference to formula (17), formula (18), and formula (19), an optimal value of yₙₚ may be obtained as follows:

$${y}_{np} = \frac{2 {i}_{np}^{*}}{( - {i}_{a} + {i}_{b} + {i}_{c} ) {d}_{v 1}} ; \qquad ( 21 )$$

and,
when the reference voltage vector is located in another sector and region, the optimal value of yₙₚ may be solved according to the foregoing method.

When the reference voltage vector is located in Sector 1, and region A₂ and B₂, the optimal value of yₙₚ is:

$${y}_{np} = \frac{2 {i}_{n p}^{*}}{( - {i}_{a} - {i}_{b} + {i}_{c} ) {d}_{v 2}} . \qquad ( 22 )$$

When the reference voltage vector is located in Sector 2, and region A₁ and B₁, the optimal value of yₙₚ is:

$${y}_{np} = \frac{2 {i}_{n p}^{*}}{( - {i}_{a} - {i}_{b} + {i}_{c} ) {d}_{v 1}} . \qquad ( 23 )$$

When the reference voltage vector is located in Sector 2, and region A₂ and B₂, the optimal value of yₙₚ is:

$${y}_{np} = \frac{2 {i}_{np}^{*}}{( {i}_{a} - {i}_{b} + {i}_{c} ) {d}_{v 2}} . \qquad ( 24 )$$

When the reference voltage vector is located in Sector 3, and region A₁ and B₁, the optimal value of yₙₚ is:

$${y}_{np} = \frac{2 {i}_{np}^{*}}{( {i}_{a} - {i}_{b} + {i}_{c} ) {d}_{v 1}} . \qquad ( 25 )$$

When the reference voltage vector is located in Sector 3, and region A₂ and B₂, the optimal value of yₙₚ is:

$${y}_{np} = \frac{2 {i}_{np}^{*}}{( {i}_{a} - {i}_{b} - {i}_{c} ) {d}_{v 2}} . \qquad ( 26 )$$

When the reference voltage vector is located in Sector 4, and region A₁ and B₁, the optimal value of yₙₚ is:

$${y}_{np} = \frac{2 {i}_{np}^{*}}{( {i}_{a} - {i}_{b} - {i}_{c} ) {d}_{v 1}} . \qquad ( 27 )$$

When the reference voltage vector is located in Sector 4, and region A₂ and B₂, the optimal value of yₙₚ is:

$${y}_{np} = \frac{2 {i}_{np}^{*}}{( {i}_{a} + {i}_{b} - {i}_{c} ) {d}_{v 2}} . \qquad ( 28 )$$

When the reference voltage vector is located in Sector 5, and region A₁ and B₁, the optimal value of yₙₚ is:

$${y}_{np} = \frac{2 {i}_{np}^{*}}{( {i}_{a} + {i}_{b} - {i}_{c} ) {d}_{v 1}} . \qquad ( 29 )$$

When the reference voltage vector is located in Sector 5, and region A₂ and B₂, the optimal value of yₙₚ is:

$${y}_{np} = \frac{2 {i}_{np}^{*}}{( - {i}_{a} + {i}_{b} - {i}_{c} ) {d}_{v 2}} . \qquad ( 30 )$$

When the reference voltage vector is located in Sector 6, and region A₁ and B₁, the optimal value of yₙₚ is:

$${y}_{np} = \frac{2 {i}_{np}^{*}}{( - {i}_{a} + {i}_{b} - {i}_{c} ) {d}_{v 1}} . \qquad ( 31 )$$

When the reference voltage vector is located in Sector 6, and region A₂ and B₂, the optimal value of yₙₚ is:

$${y}_{np} = \frac{2 {i}_{np}^{*}}{( - {i}_{a} + {i}_{b} + {i}_{c} ) {d}_{v 2}} . \qquad ( 32 )$$

### 4. Design of a Switching Sequence

Considering factors such as low output harmonic content, small impact of a dead-time, and a small quantity of actions of a power switch of the coupled TLI, the switching sequence is designed.

When the reference voltage vector is located in region A₁ in Sector 1, design a five-segment switching sequence as follows: [PNN]-[POO]-[PPN]-[ONN]-[PNN].

When the reference voltage vector is located in region A₂ in Sector 1, design a five-segment switching sequence as follows: [PNN]-[PPO]-[PPN]-[OON]-[PNN].

When the reference voltage vector is located in region B₁ in Sector 1, design a five-segment switching sequence as follows: [PPN]-[POO]-[OOO]-[ONN]-[PPN].

When the reference voltage vector is located in region B₂ in Sector 1, design a five-segment switching sequence as follows: [PPN]-[POO]-[OOO]-[ONN]-[PPN].

When the reference voltage vector is located in region A₁ in Sector 2, design a five-segment switching sequence as follows: [PPN]-[PPO]-[NPN]-[OON]-[PPN].

When the reference voltage vector is located in region A₂ in Sector 2, design a five-segment switching sequence as follows: [PPN]-[OPO]-[NPN]-[NON]-[PPN].

When the reference voltage vector is located in region B₁ in Sector 2, design a five-segment switching sequence as follows: [NPN]-[PPO]-[OOO]-[OON]-[NPN].

When the reference voltage vector is located in region B₂ in Sector 2, design a five-segment switching sequence as follows: [PPN]-[OPO]-[OOO]-[NON]-[PPN].

When the reference voltage vector is located in region A₁ in Sector 3, design a five-segment switching sequence as follows: [NPN]-[OPO]-[NPP]-[NON]-[NPN].

When the reference voltage vector is located in region A₂ in Sector 3, design a five-segment switching sequence as follows: [NPN]-[OPP]-[NPP]-[NOO]-[NPN].

When the reference voltage vector is located in region B₁ in Sector 3, design a five-segment switching sequence as follows: [NPP]-[OPO]-[OOO]-[NON]-[NPP].

When the reference voltage vector is located in region B₂ in Sector 3, design a five-segment switching sequence as follows: [NPN]-[OPP]-[OOO]-[NOO]-[NPN].

When the reference voltage vector is located in region A₁ in Sector 4, design a five-segment switching sequence as follows: [NPP]-[OPP]-[NNP]-[NOO]-[NPP].

When the reference voltage vector is located in region A₂ in Sector 4, design a five-segment switching sequence as follows: [NPP]-[OOP]-[NNP]-[NNO]-[NPP].

When the reference voltage vector is located in region B₁ in Sector 4, design a five-segment switching sequence as follows: [NNP]-[OPP]-[OOO]-[NOO]-[NNP].

When the reference voltage vector is located in region B₂ in Sector 4, design a five-segment switching sequence as follows: [NPP]-[OOP]-[OOO]-[NNO]-[NPP].

When the reference voltage vector is located in region A₁ in Sector 5, design a five-segment switching sequence as follows: [NNP]-[OOP]-[PNP]-[NNO]-[NNP].

When the reference voltage vector is located in region A₂ in Sector 5, design a five-segment switching sequence as follows: [NNP]-[POP]-[PNP]-[ONO]-[NNP].

When the reference voltage vector is located in region B₁ in Sector 5, design a five-segment switching sequence as follows: [PNP]-[OOP]-[OOO]-[NNO]-[PNP].

When the reference voltage vector is located in region B₂ in Sector 5, design a five-segment switching sequence as follows: [NNP]-[POP]-[OOO]-[ONO]-[NNP].

When the reference voltage vector is located in region A₁ in Sector 6, design a five-segment switching sequence as follows: [PNP]-[POP]-[PNN]-[ONO]-[PNP].

When the reference voltage vector is located in region A₂ in Sector 6, design a five-segment switching sequence as follows: [PNP]-[POO]-[PNN]-[ONN]-[PNP].

When the reference voltage vector is located in region B₁ in Sector 6, design a five-segment switching sequence as follows: [PNN]-[POP]-[OOO]-[ONO]-[PNN].

When the reference voltage vector is located in region B₂ in Sector 6, design a five-segment switching sequence as follows: [PNP]-[POO]-[OOO]-[ONN]-[PNP].

The switching sequence is converted into a drive signal of a power switch, to control the coupled TLI system to operate.

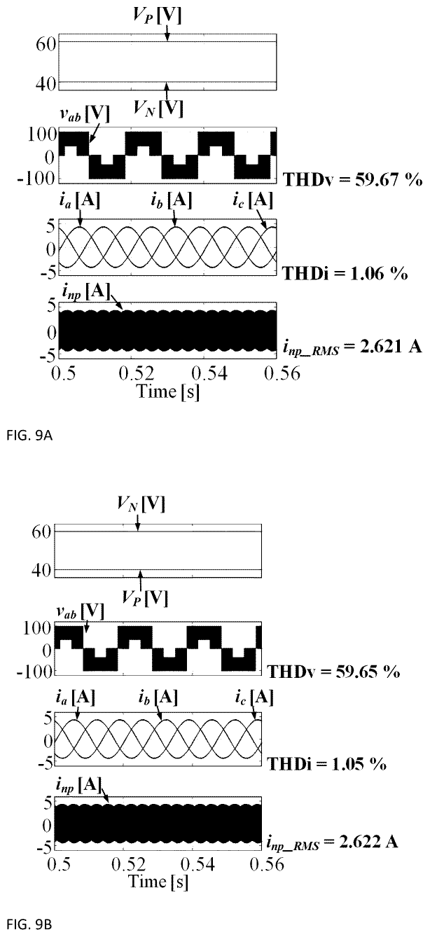

FIG. 8 is a principle diagram of a method for suppressing a DC-Link CCR according to Example 1 of the present invention.

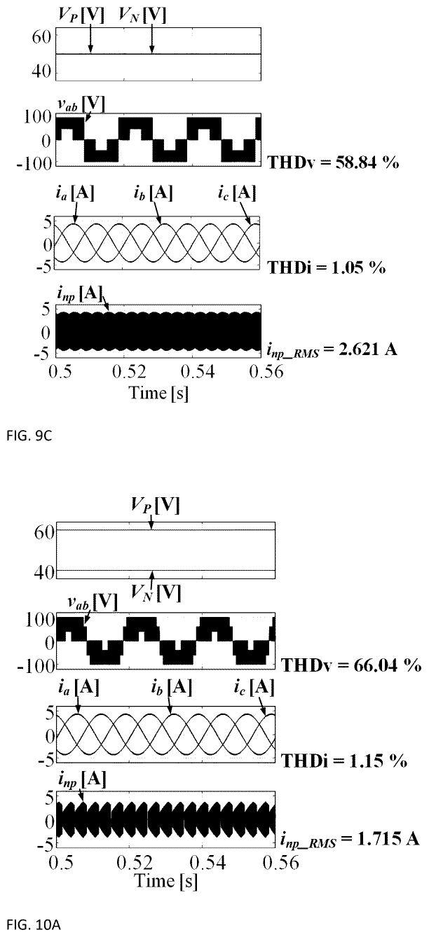

FIG. 9 is a simulation waveform diagram in which a system uses a conventional space vector modulation method with a modulation index of 0.8, including DC-Link capacitor voltages (V_{P} and V_{N}), a line voltage (V_{ab}), an A-phase output voltage (iₐ), and a neutral point current (iₙₚ). An unbalanced coefficient in FIG. 9A is set to 0.2, an unbalanced coefficient in FIG. 9B is set to −0.2, and an unbalanced coefficient in FIG. 9C is set to 0. In this case, an input voltage on the DC-Link is set to 100 V. It can be seen that a DC-Link CCR of the system is very high, and effective values of the DC-Link CCR of the system are respectively as high as 2.621 A, 2.622 A, and 2.621 A.

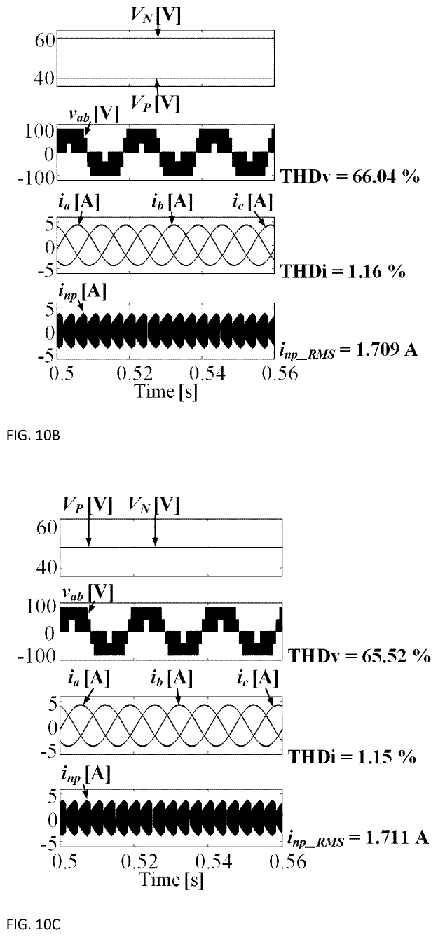

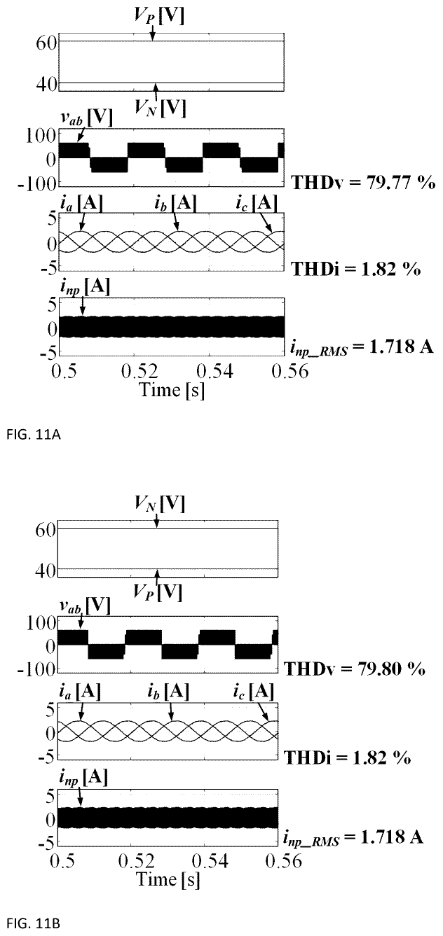

FIG. 10 is a simulation waveform diagram in which a system uses a control method of Example 1 of the present invention with a modulation index of 0.8. An unbalanced coefficient in FIG. 10A is set to 0.2, an unbalanced coefficient in FIG. 10B is set to −0.2, and an unbalanced coefficient in FIG. 10C is set to 0. In this case, a system line voltage has a five-level waveform, and the output current has a sinusoidal waveform. The effective values of the DC-Link CCR of the system are respectively reduced to 1.715 A, 1.709 A, and 1.711 A. It can be seen that the DC-Link CCRs of the system are respectively 65.43%, 65.18%, and 65.28% of those in the conventional space vector modulation method, and good output current quality is maintained. This is of obvious advantages.

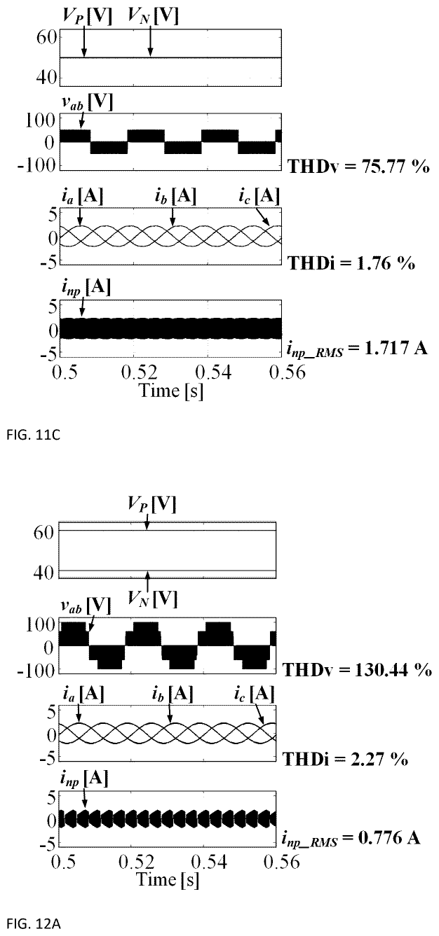

FIG. 11 is a simulation waveform diagram in which a system uses a conventional space vector modulation method with a modulation index of 0.4. An unbalanced coefficient in FIG. 11A is set to 0.2, an unbalanced coefficient in FIG. 11B is set to −0.2, and an unbalanced coefficient in FIG. 11C is set to 0. It can be seen that the line voltage (V_{ab}) is reduced to be in a three-level waveform, the output current quality of the system is reduced, and total harmonic distortions (THDᵢ) of the output current of the system are respectively 1.82%, 1.82%, and 1.76%. The DC-Link CCR of the system is very high, and the DC-Link CCRs of the system are respectively as high as 1.718 A, 1.718 A, and 1.718 A.

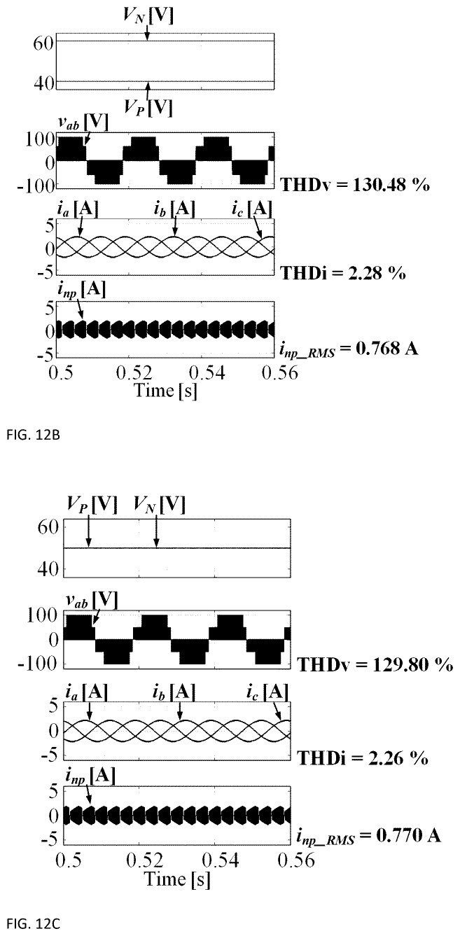

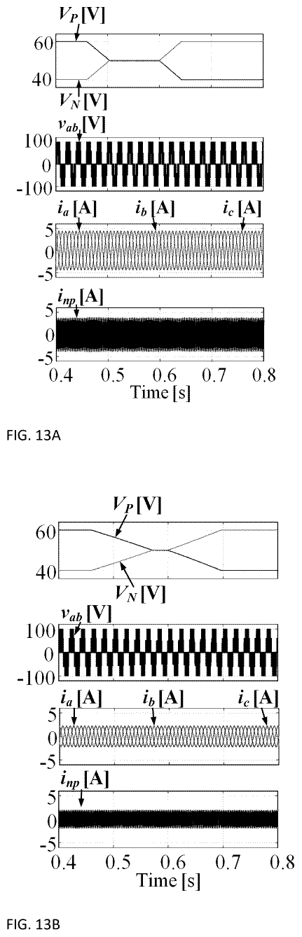

FIG. 12 is a simulation waveform diagram in which a system uses a control method of Example 1 of the present invention with a modulation index of 0.4. An unbalanced coefficient in FIG. 12A is set to 0.2, an unbalanced coefficient in FIG. 12B is set to −0.2, and an unbalanced coefficient in FIG. 12C is set to 0. In this case, a line voltage has a five-level waveform, and the output current has a sinusoidal waveform. The DC-Link CCRs of the system are respectively reduced by 54.83%, 55.30%, and 55.15% of those in the conventional space vector modulation method. This is of obvious advantages.

FIG. 13 is a simulation waveform diagram in which a system uses a control method of Example 1 of the present invention when a step change occurs in a set value of a voltage difference across capacitors. It can be seen that, according to the control method in Example 1 of the present invention, two capacitor voltages on the DC-Link can be separately controlled. In addition, in the control method of Example 1 of the present invention, good waveform quality of the output current is maintained while the DC-Link CCR is suppressed in a dynamic case.

### Example 2

The present example provides a system for suppressing a DC-Link CCR of a coupled TLI, including:
A sector division module, configured to determine a region division method of a space vector diagram of a coupled TLI based on a value range of a duty cycle distribution factor of a virtual voltage vector;
A sector determining module, configured to determine, based on an amplitude, a phase angle, and a three-phase output current of a reference voltage vector, a sector and a region in which the reference voltage vector is located;
A basic voltage vector selection module, configured to select, based on the sector and the region in which the reference voltage vector is located, nearest one virtual voltage vector and two basic voltage vectors, to calculate duty cycles of the nearest one virtual voltage vector and two basic voltage vectors respectively;
A capacitor voltage separate control module, configured to: design a controller, update a duty cycle distribution factor of a small vector, and realize separate control of capacitor voltages based on the sector and the region in which the reference voltage vector is located, a set value of a voltage difference across DC-Link capacitors, and an actual value of a voltage difference across DC-Link capacitors according to a deadbeat control method;
A drive signal generation module, configured to: design a switching sequence based on an updated small vector duty cycle and the sector and the region in which the reference voltage vector is located, and convert the switching sequence into a PWM drive signal of a power switch, to control the coupled TLI to operate.

The above modules have same examples and application scenarios in which the corresponding steps are implemented, but are not limited to content disclosed in Example 1. It should be noted that, as a part of the system, the foregoing modules may be executed in, for example, a computer system having a group of computer executable instructions.

In the foregoing examples, the descriptions of the examples have their respective focuses. For a part that is not described in detail in an example, refer to related descriptions in other examples.

The proposed system may be implemented in other manners. For example, the system examples described above are merely examples. For example, division into the modules is merely a logical function division and there may be other division in actual implementation. For example, a plurality of modules may be combined or integrated into another system, or some features may be ignored or not performed.

### Example 3

The present example provides a computer-readable storage medium, having a computer program stored thereon, where when the program is executed by a processor, the steps of the method for suppressing a DC-Link CCR of a coupled TLI according to Example 1 are implemented.

### Example 4

The present example provides a computer device, including a memory, a processor, and a computer program that is stored in the memory and that can be run on the processor, where when the processor executes the program, the steps of the method for suppressing a DC-Link CCR of a coupled TLI according to Example 1 are implemented.

A person skilled in the art should understand that the examples of the present invention may be provided as a method, a system, or a computer program product. Therefore, the present invention may use a form of hardware examples, software examples, or examples with a combination of software and hardware. Moreover, the present invention may use a form of a computer program product that is implemented on one or more computer-usable storage media (including but not limited to a disk memory, an optical memory, and the like) that include computer-usable program code.

The present invention is described with reference to the flowcharts and/or block diagrams of the method, the device (system), and the computer program product according to the examples of the present invention. It should be understood that computer program instructions may be used to implement each procedure and/or each block in the flowcharts and/or the block diagrams and a combination of a procedure and/or a block in the flowcharts and/or the block diagrams. These computer program instructions may be provided to a general-purpose computer, a dedicated computer, an embedded processor, or a processor of another programmable data processing device to generate a machine, so that the instructions executed by the computer or the processor of the another programmable data processing device generate an apparatus for implementing a specified function in one or more procedures in the flowcharts and/or in one or more blocks in the block diagrams.

These computer program instructions may alternatively be stored in a computer-readable memory that can instruct the computer or another programmable data processing device to work in a specific manner, so that the instructions stored in the computer-readable memory generate an artifact that includes an instruction apparatus. The instruction apparatus implements a specified function in one or more procedures in the flowcharts and/or in one or more blocks in the block diagrams.

These computer program instructions may alternatively be loaded onto the computer or another programmable data processing device, so that a series of operational steps are performed on the computer or another programmable device for a process implemented by the computer. Therefore, the instructions executed on the computer or another programmable device provides steps for implementing the specified function in one or more procedures in the flowcharts and/or in one or more blocks in the block diagrams.

A person of ordinary skill in the art may understand that all or some of the procedures of the methods of the foregoing examples may be implemented by a computer program instructing relevant hardware. The program may be stored in a computer-readable storage medium. When the program is executed, the procedures of the examples of the foregoing methods can be included. The foregoing storage medium may include a magnetic disc, an optical disc, a read-only memory (Read-Only Memory, ROM), a random access memory (Random Access Memory, RAM), or the like.

The specific implementations of the present invention are described above with reference to the accompanying drawings, but are not intended to limit the protection scope of the present invention. A person skilled in the art should understand that various modifications or deformations may be made without creative efforts based on the technical solutions of the present invention, and such modifications or deformations shall fall within the protection scope of the present invention.

1. A method for suppressing a direct current-link (DC-Link) capacitor current ripple (CCR) of a coupled three-level inverter (TLI), comprising:
determining a region division method of a space vector diagram of a coupled TLI based on a value range of a duty cycle distribution factor of a virtual voltage vector, specifically: separately synthesizing a first virtual voltage vector and a second virtual voltage vector based on two pairs of small vectors in a first sector in the space vector diagram of the coupled TLI; determining, based on two virtual voltage vectors and two large vectors, duty cycles of the two virtual voltage vectors according to an indirect method; calculating duty cycle distribution factors of the virtual voltage vectors based on the duty cycles of the two virtual voltage vectors; determining value ranges of the duty cycle distribution factors of the two virtual voltage vectors by considering a value range of a large vector, and considering that a duty cycle distribution factor of a small vector and a DC-Link unbalanced factor are equal to zero; determining, based on a maximum value and a minimum value of the duty cycle distribution factors of the virtual voltage vectors, two straight lines passing through the first sector, wherein each of the two straight lines represents a connection line between a virtual voltage vector and a large vector; performing region division on the first sector of the space vector diagram of the coupled TLI by using the two straight lines as a region division condition; and when the maximum value of the duty cycle distribution factors of the virtual voltage vectors is 1, obtaining that:
$$3 {V}_{ref} cos θ - \sqrt{3} ( 2 α μ - μ ) {V}_{ref} sin θ = ( 1 + 2 α μ - μ ) {V}_{d c} ;$$
when the minimum value of the duty cycle distribution factors of the virtual voltage vectors is 0, obtaining that:
$$3 ( 1 + 2 α μ - μ ) {V}_{ref} cos θ + \sqrt{3} ( 3 - 2 α μ + μ ) {V}_{ref} sin θ = ( 1 + 2 α μ - μ ) {V}_{d c} ;$$
wherein μ is a DC-Link unbalanced factor, α is a duty cycle distribution factor of a small vector, V_{ref} is a reference voltage vector, and V_{dc} is a sum of voltages across two DC-Link capacitors;
determining, based on an amplitude, a phase angle, and a three-phase output current of the reference voltage vector, a sector and a region in which the reference voltage vector is located;
selecting, based on the sector and the region in which the reference voltage vector is located, nearest one virtual voltage vector and two basic voltage vectors, to calculate duty cycles of the nearest one virtual voltage vector and two basic voltage vectors respectively;
designing a controller, updating the duty cycle distribution factor of the small vector, and realizing separate control of capacitor voltages based on the sector and the region in which the reference voltage vector is located, a set value of a voltage difference across DC-Link capacitors, and an actual value of a voltage difference across DC-Link capacitors according to a deadbeat control method; and
designing a switching sequence based on an updated small vector duty cycle and the sector and the region in which the reference voltage vector is located, and converting the switching sequence into a PWM drive signal of a power switch, to control the coupled TLI to operate.

2. The method for suppressing a DC-Link CCR of a coupled TLI according to claim 1, wherein the selecting nearest one virtual voltage vector and two basic voltage vectors, to calculate duty cycles of the nearest one virtual voltage vector and two basic voltage vectors respectively is specifically:
separately synthesizing the first virtual voltage vector and the second virtual voltage vector based on the two pairs of small vectors in the first sector in the space vector diagram of the coupled TLI;
determining, based on the two virtual voltage vectors and the two large vectors, the duty cycles of the two virtual voltage vectors and duty cycles of the two large vectors according to the indirect method; and
discarding a virtual voltage vector with high neutral point current amplitude, and selecting another virtual voltage vector and two basic voltage vectors, to calculate duty cycles of the another virtual voltage vector and two basic voltage vectors respectively.

3. The method for suppressing a DC-Link CCR of a coupled TLI according to claim 1, wherein the designing a controller, updating the duty cycle distribution factor of the small vector, and realizing separate control of capacitor voltages based on the sector and the region in which the reference voltage vector is located, a set value of a voltage difference across DC-Link capacitors, and an actual value of a voltage difference across DC-Link capacitors according to a deadbeat control method is specifically:
determining a discrete model of a neutral point current based on the set value of the voltage difference across DC-Link capacitors and the actual value of the voltage difference across DC-Link capacitors;
designing the controller based on the discrete model of the neutral point current according to the deadbeat control method, to adjust a neutral-point voltage;
determining a relationship between a neutral point current and a duty cycle distribution factor of a small vector in the first sector based on the sector and the region in which the reference voltage vector is located; and
updating the duty cycle of the small vector based on the neutral point current, to implement separate control of capacitor voltages.

4. The method for suppressing a DC-Link CCR of a coupled TLI according to claim 1, wherein the designing a switching sequence based on an updated small vector duty cycle and the sector and the region in which the reference voltage vector is located is specifically:
determining an expression of an optimal value of an intermediate variable in the first sector based on a relationship between a neutral point current and a duty cycle of a small vector selected in the first sector, and a reference value of the neutral point current;
determining, based on the expression of the optimal value of the intermediate variable in the first sector, an optimal value of the intermediate variable when the reference voltage vector is located in another sector and region;
determining the duty cycle distribution factor of the small vector based on a magnitude of the neutral point current; and
designing different switching sequences based on optimal values of intermediate variables obtained when the reference voltage is located in different sectors and regions.

5. The method for suppressing a DC-Link CCR of a coupled TLI according to claim 1, wherein the designing a switching sequence is specifically:
when the reference voltage vector is located in region A₁ in Sector 1, designing a five-segment switching sequence as follows: [PNN]-[POO]-[PPN]-[ONN]-[PNN];
when the reference voltage vector is located in region A₂ in Sector 1, designing a five-segment switching sequence as follows: [PNN]-[PPO]-[PPN]-[OON]-[PNN];
when the reference voltage vector is located in region B₁ in Sector 1, designing a five-segment switching sequence as follows: [PPN]-[POO]-[OOO]-[ONN]-[PPN];
when the reference voltage vector is located in region B₂ in Sector 1, designing a five-segment switching sequence as follows: [PPN]-[POO]-[OOO]-[ONN]-[PPN];
when the reference voltage vector is located in region A₁ in Sector 2, designing a five-segment switching sequence as follows: [PPN]-[PPO]-[NPN]-[OON]-[PPN];
when the reference voltage vector is located in region A₂ in Sector 2, designing a five-segment switching sequence as follows: [PPN]-[OPO]-[NPN]-[NON]-[PPN];
when the reference voltage vector is located in region B₁ in Sector 2, designing a five-segment switching sequence as follows: [NPN]-[PPO]-[OOO]-[OON]-[NPN];
when the reference voltage vector is located in region B₂ in Sector 2, designing a five-segment switching sequence as follows: [PPN]-[OPO]-[OOO]-[NON]-[PPN];
when the reference voltage vector is located in region A₁ in Sector 3, designing a five-segment switching sequence as follows: [NPN]-[OPO]-[NPP]-[NON]-[NPN];
when the reference voltage vector is located in region A₂ in Sector 3, designing a five-segment switching sequence as follows: [NPN]-[OPP]-[NPP]-[NOO]-[NPN];
when the reference voltage vector is located in region B₁ in Sector 3, designing a five-segment switching sequence as follows: [NPP]-[OPO]-[OOO]-[NON]-[NPP];
when the reference voltage vector is located in region B₂ in Sector 3, designing a five-segment switching sequence as follows: [NPN]-[OPP]-[OOO]-[NOO]-[NPN];
when the reference voltage vector is located in region A₁ in Sector 4, designing a five-segment switching sequence as follows: [NPP]-[OPP]-[NNP]-[NOO]-[NPP];
when the reference voltage vector is located in region A₂ in Sector 4, designing a five-segment switching sequence as follows: [NPP]-[OOP]-[NNP]-[NNO]-[NPP];
when the reference voltage vector is located in region B₁ in Sector 4, designing a five-segment switching sequence as follows: [NNP]-[OPP]-[OOO]-[NOO]-[NNP];
when the reference voltage vector is located in region B₂ in Sector 4, designing a five-segment switching sequence as follows: [NPP]-[OOP]-[OOO]-[NNO]-[NPP];
when the reference voltage vector is located in region A₁ in Sector 5, designing a five-segment switching sequence as follows: [NNP]-[OOP]-[PNP]-[NNO]-[NNP];
when the reference voltage vector is located in region A₂ in Sector 5, designing a five-segment switching sequence as follows: [NNP]-[POP]-[PNP]-[ONO]-[NNP];
when the reference voltage vector is located in region B₁ in Sector 5, designing a five-segment switching sequence as follows: [PNP]-[OOP]-[OOO]-[NNO]-[PNP];
when the reference voltage vector is located in region B₂ in Sector 5, designing a five-segment switching sequence as follows: [NNP]-[POP]-[OOO]-[ONO]-[NNP];
when the reference voltage vector is located in region A₁ in Sector 6, designing a five-segment switching sequence as follows: [PNP]-[POP]-[PNN]-[ONO]-[PNP];
when the reference voltage vector is located in region A₂ in Sector 6, designing a five-segment switching sequence as follows: [PNP]-[POO]-[PNN]-[ONN]-[PNP];
when the reference voltage vector is located in region B₁ in Sector 6, designing a five-segment switching sequence as follows: [PNN]-[POP]-[OOO]-[ONO]-[PNN]; and
when the reference voltage vector is located in region B₂ in Sector 6, designing a five-segment switching sequence as follows: [PNP]-[POO]-[OOO]-[ONN]-[PNP].

6. A system for suppressing a direct current-link (DC-Link) CCR of a coupled TLI, comprising:
a sector division module, configured to determine a region division method of a space vector diagram of a coupled TLI based on a value range of a duty cycle distribution factor of a virtual voltage vector, specifically: separately synthesize a first virtual voltage vector and a second virtual voltage vector based on two pairs of small vectors in a first sector in the space vector diagram of the coupled TLI; determine, based on two virtual voltage vectors and two large vectors, duty cycles of the two virtual voltage vectors according to an indirect method; calculate duty cycle distribution factors of the virtual voltage vectors based on the duty cycles of the two virtual voltage vectors; determine value ranges of the duty cycle distribution factors of the two virtual voltage vectors by considering a value range of a large vector, and considering that a duty cycle distribution factor of a small vector and a DC-Link unbalanced factor are equal to zero;
determine, based on a maximum value and a minimum value of the duty cycle distribution factors of the virtual voltage vectors, two straight lines passing through the first sector, wherein each of the two straight lines represents a connection line between a virtual voltage vector and a large vector; perform region division on the first sector of the space vector diagram of the coupled TLI by using the two straight lines as a region division condition; and when the maximum value of the duty cycle distribution factors of the virtual voltage vectors is 1, obtain that:
$$3 {V}_{ref} cos θ - \sqrt{3} ( 2 α μ - μ ) {V}_{ref} sin θ = ( 1 + 2 α μ - μ ) {V}_{d c} ;$$
when the minimum value of the duty cycle distribution factors of the virtual voltage vectors is 0, obtain that:
$$3 ( 1 + 2 α μ - μ ) {V}_{ref} cos θ + \sqrt{3} ( 3 - 2 α μ + μ ) {V}_{ref} sin θ = ( 1 + 2 α μ - μ ) {V}_{d c} ;$$
wherein μ is a DC-Link unbalanced factor, α is a duty cycle distribution factor of a small vector, V_{ref} is a reference voltage vector, and V_{dc} is a sum of voltages across two DC-Link capacitors;
a sector determining module, configured to determine, based on an amplitude, a phase angle, and a three-phase output current of the reference voltage vector, a sector and a region in which the reference voltage vector is located;
a basic voltage vector selection module, configured to select, based on the sector and the region in which the reference voltage vector is located, nearest one virtual voltage vector and two basic voltage vectors, to calculate duty cycles of the nearest one virtual voltage vector and two basic voltage vectors respectively;
a capacitor voltage separate control module, configured to: design a controller, update a duty cycle distribution factor of a small vector, and realize separate control of capacitor voltages based on the sector and the region in which the reference voltage vector is located, a set value of a voltage difference across DC-Link capacitors, and an actual value of a voltage difference across DC-Link capacitors according to a deadbeat control method; and
a drive signal generation module, configured to: design a switching sequence based on an updated small vector duty cycle and the sector and the region in which the reference voltage vector is located, and convert the switching sequence into a PWM drive signal of a power switch, to control the coupled TLI to operate.

7. A computer-readable storage medium, having a computer program stored thereon, wherein when the program is executed by a processor, the steps of the method for suppressing the DC-Link CCR of a coupled TLI according to claim 1 are implemented.

8. A computer device, comprising a memory, a processor, and a computer program that is stored in the memory and that can be run on the processor, wherein when the processor executes the program, the steps of the method for suppressing the DC-Link CCR of a coupled TLI according to claim 1 are implemented.
